(19) United States
(12) Patent Application Publication
(10) Pub. No.: US 2010/0313116 A1
(43) Pub. Date: Dec. 9, 2010

(54) Microsite Delivery

(76) Inventor: Michael Hyman, Bellevue, WA (US)

Correspondence Address: SoCAL IP LAW GROUP LLP, 310 N. WESTLAKE BLVD. STE 120, WESTLAKE VILLAGE, CA, 91362, US

(21) Appl. No.: 12/794,566

(22) Filed: Jun. 4, 2010

Related U.S. Application Data
(60) Provisional application No. 61/184,697, filed on Jun. 5, 2009.

(51) Int. Cl. G06F 17/00

(52) U.S. Cl. 715/240; 709/203

(57) ABSTRACT

Methods and machine readable media for delivering online advertisements. A client computing may receive a first web page including data identifying an ad unit to be incorporated into the first web page. The client computer may request content for the ad unit content from an ad server. The ad server may download a shell to the client computer. Running the shell may cause the client computer to perform actions including loading from the ad server ad unit code defining the ad unit content; receiving from the ad server a URL of a second web page; opening an HTML iframe element positioned to overlay at least a portion of the ad unit within the first web page; and delivering the first web page, the ad unit, and at least a portion of the second web page displayed within the HTML iframe element.

### RELATED APPLICATION INFORMATION

This patent claims priority from Provisional Application No. 61/184,697, filed Jun. 5, 2009, entitled “Microsite Delivery”, incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to placing advertisements in web pages accessed via the Internet, and specifically to embedding a microsite or other web page within an ad unit.

2. Description of the Related Art

The Internet and the World Wide Web have made a vast body of knowledge available to anyone with a computer and a network connection. As of 2009, the World Wide Web included about 180 million websites.

Many companies and other organizations have invested in enterprise websites that include much, if not all, of their publicly available information organized in a complex hierarchical structure having hundreds or thousands of web pages. Such websites may have sections devoted to product marketing and sales, public relations, investor relations, news, employee relations, and other topics. Companies and other organizations may also invest in building microsites. Microsites are compact, self-contained, websites focused on one particular product or topic, such as a movie, a beverage or food, some other consumer product, or a service. A microsite typically has its own unique URL (uniform resource locator) and is separate from the owner's primary website. Microsites are commonly accessed by a user selecting a link on a search results screen.

Within this patent, the term “publisher” means a company, government entity, or other organization that provides a web site accessible via the internet. Publishers may provide all of the content of their web sites, or may embed content provided by other sources. For example, many websites are supported, at least in part, by advertisements presented within web pages. Publishers of ad-support web sites may sell space on their web pages for advertisements.

In this patent, an “ad broker” is a company that places ads in publisher web pages. The ad broker may broker such ad space between publishers and advertisers. The ad broker may act as a media buyer that purchases ad space from publishers and sells the space to various advertisers or advertising agencies.

Traditionally, web pages were written in Hypertext Markup Language (HTML). Currently, to provide a variety of content including audio, video, and/or animation, web pages may be written in a combination of HTML and other platforms including Extended Markup Language (XML), Java, and Adobe Flash. Most ads to be embedded in web pages are written using Flash. Flash is a multimedia platform including a suite of program instructions, data structures, and file formats used to create objects that can be played or rendered by a Flash player coupled to a web browser.

Flash supports text, graphics, animation, audio, video, and/or viewer interaction. However, an HTML document or web page cannot be opened within an ad or other object written in Flash. Thus, while Flash objects may include links to take a user to a microsite, traditional Flash objects cannot bring a microsite or other web page to a user.

Most web page ads conform to standards set by an industry association, the Interactive Advertising Bureau (IAB). The IAB has defined a plurality of standard ad formats, commonly referred to as “ad units”. Within this patent, the term “ad unit object” refers to the programming code and associated data that causes an ad unit to be rendered within a web page. Ad unit objects are typically Flash objects hosted on servers operated by an advertising broker or a third-party provider. An ad unit object may be written by the advertising broker, the third-party provider, or the advertiser.

### DESCRIPTION OF THE DRAWINGS

FIG. 1 is a block diagram of a network environment.

FIG. 2 is a block diagram of a computing device.

FIG. 3 is a flow chart of a method for presenting a second web page within an object on a first web page.

FIG. 4A is a graphical depiction of a display screen.

FIG. 4B is a graphical depiction of layers within a web page.

FIG. 5 is a flow chart of a method for presenting a second web page within an object on a first web page.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

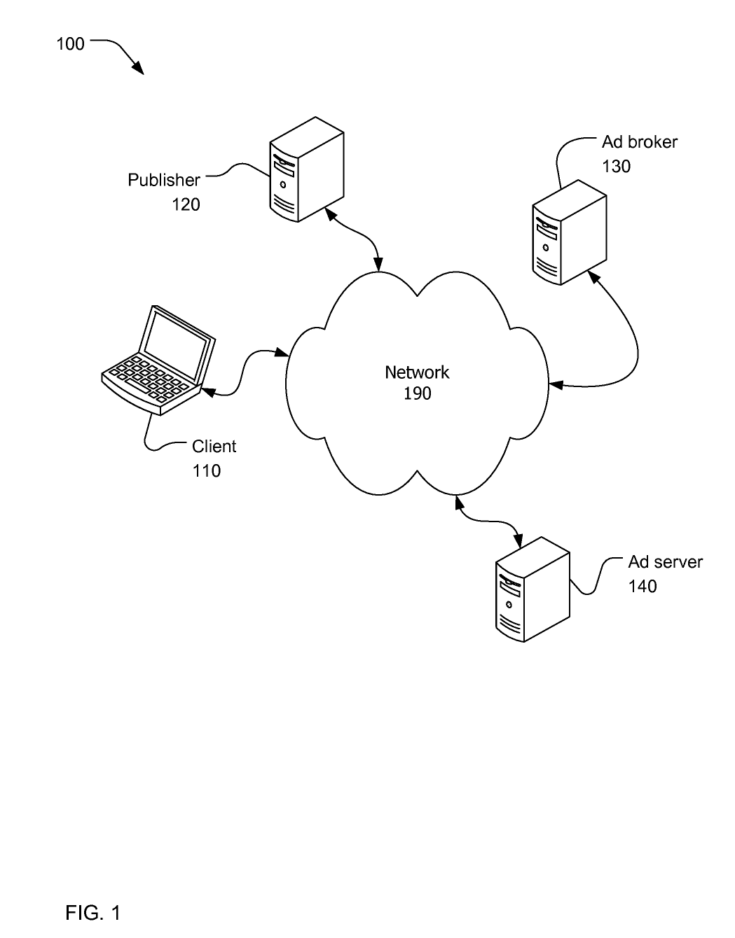

Referring now to FIG. 1, a network environment 100 may include a client computer 110, a publisher server 120, an ad broker server 130, and an ad server 140 coupled via a network 190. The network 190 may be or include the Internet. Although FIG. 1 shows, for ease of explanation, a single client computer and three servers, it must be understood that millions of clients and many thousands of servers may be connected to the Internet simultaneously.

The client computer 110 may be used by a “requestor” to access the Internet including the World Wide Web. Although shown as a portable computer, the client computer 110 may be any computing device including, but not limited to, a desktop personal computer, a portable computer, a laptop computer, a computing tablet, a set top box, a video game system, a personal video recorder, a telephone, or a personal digital assistant.

The publisher server 120 may store and “serve”, or provide, web pages in response to requests received via the network 190 from other devices such as the client computer 110. When a web page to be served includes one or more regions allocated for ad units, the publisher server may request the ad broker server to provide data defining the ad units to be incorporated into the web page.

The ad broker server 130 may store contracts or rules defining relationships between the ad broker and a plurality of publishers and between the ad broker and a plurality of advertisers. When the publisher server 120 requests data identifying an ad to be placed in a web page, the publisher server may select an advertisement and provide the requested identifying data.

The ad server 140 may store one or more ad unit objects defining one or more ads. After an ad has been selected by the ad broker server 130, the ad server may provide the ad unit object for the select ad in response to a request from the publisher server 120 or the client computer 110.

The ad broker server 130 and the ad server 140 may be physically or geographically separate, or the ad broker server 130 and the ad server 140 may be combined in a single server or cluster of servers. The ad broker server 130 and the ad server 140 may be controlled by separate business entities or by a single business. Some or all of the publisher server 120, ad broker server 130 and the ad server 140 may virtual servers within a cloud.

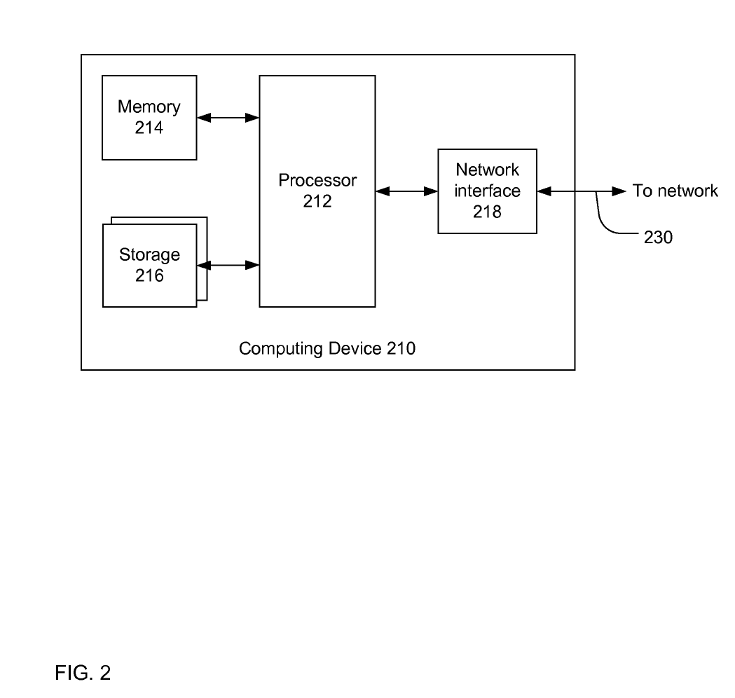

Each of the client computer 110, the publisher server 120, the ad broker server 130, and the ad server 140 may be a computing device 210, as shown in FIG. 2. The computing device 210 may include at least one processor 212, memory 214, and a network interface 218. Servers, in particular may contain a plurality of processors. The computing device 210 may include or be coupled to one or more storage devices 216. A client computer may also include or be coupled to a display device and user input devices, such as a keyboard and mouse, not shown in FIG. 2.

Each of the client computer 110, the publisher server 120, the ad broker server 130, and the ad server 140 may execute software instructions to perform the actions and methods described herein. The software instructions may be stored on a machine readable storage media a storage device such as the storage device 216. These storage media include, for example, magnetic media such as hard disks, floppy disks and tape; optical media such as compact disks (CD-ROM and CD-RW) and digital versatile disks (DVD and DVD±RW); flash memory cards; and other storage media. The term “storage media” is not intended to encompass a transient medium, such as a signal or a waveform, conveying software instructions or other data.

The client computer may run an operating system, including, for example, variations of the Linux, Microsoft Windows, Symbian, and Apple Mac operating systems. To access the Internet, the client computer may run a browser such as Microsoft Explorer or Mozilla Firefox, and an e-mail program such as Microsoft Outlook or Lotus Notes. Each of the publisher server 120, the ad broker server 130, and the ad server 140 may run an operating system and one or more application programs to perform the actions and methods described herein.

Each of the client computer 110 and the servers 120, 130, 140 may include various specialized units, circuits, firmware, software and interfaces for providing the functionality and features described here. The processes, functionality and features may be embodied in whole or in part in software executed by a processor. The hardware, firmware, and software and their functions may be distributed such that some function and features are performed by a processor and others by other devices.

Description of Processes

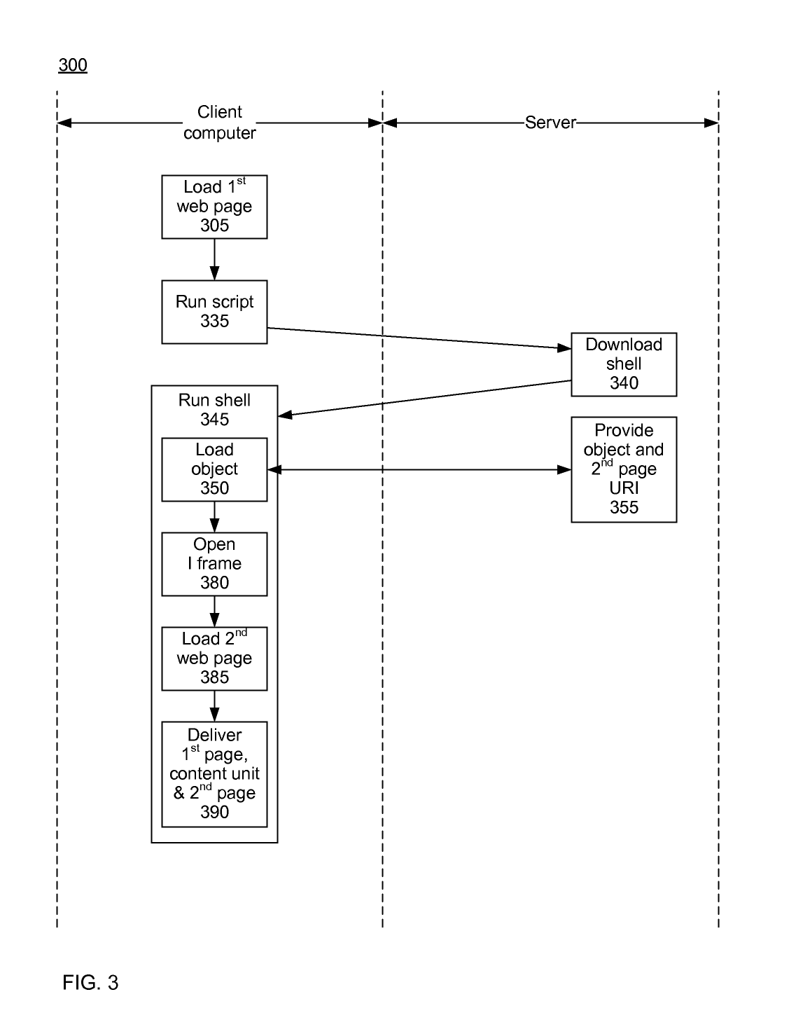

FIG. 3 is a flow chart of a process 300 for delivering a requested first web page including a content unit that incorporates, or appears to incorporate, all or a portion of a second web page. In this patent, the term “content unit” means content that is incorporated by a client computer into a web page, but is provided by a party other than the publisher of the web page. Commonly, the content unit may be an ad unit. However, the process 300 may be used with other types of content. The first web page may be a publisher web page, and the second web page may be, for example, a microsite provided by an advertiser or other party on behalf of an advertiser. The process 300 may be performed by a client computer and a server, which may be the ad server 140 of FIG. 1, coupled by a network.

The process 300 may be considered to start at 305, when a client computer loads a first web page, typically in response to an action by an operator or requestor. The process 300 may be considered to end at 390, when the first web page, which includes a content unit apparently containing the second web page, is delivered to the requestor. In this patent, the term “deliver” specifically means providing the multimedia content of a web page. Delivering a web page may include displaying static visual components, such as text and graphics, on a display device coupled to the client computer. Delivering the web page may include playing dynamic visual components, such as animations and video clips, on the display device. Delivering the web page may also include playing one or more audio components. Delivering the web page may also include displaying entry forms for gathering information from users, or displaying additional advertisements.

The process 300 will usually be cyclical in nature, since the process 300 may be repeated for some or all of plurality of web pages visited by the requestor while browsing the Web. The process 300 may be performed numerous times in parallel as web pages are concurrently provided to a large plurality of client computers. The process may also be performed numerous times in parallel if a single web page provides a plurality of advertisements.

At 305, the client computer may load the first web page from a publisher server. The first web page may include information identifying a content unit to be loaded from a server. The information identifying the content unit may be, for example, a script or a call to an ad broker embedded in the first web page by its publisher.

After loading the first web page from the publisher computer at 305, a browser program running on the client computer may render the first web page for delivery to the requestor. As part of rendering the first web page, at 335 the client computer may request the content unit from a server in accordance with the information identifying the content unit contained in the first web page. For example, at 335, the client computer may execute a script contained within the first web page. When executed at 335, the script may cause the client computer to request the content unit from the server.

In response to the request from the client computer, the ad server may download a shell to the client computer at 340. The shell may be executable HTML code or other code that forms an outer layer of the content unit. The shell may include a component for loading other elements of the content unit, and a component for managing the interface between the content unit and the client computer, the browser, and/or the requestor. The shell may include other components such as, for example, a component to monitor and report the requestor's interaction with the content unit.

The client computer may run the downloaded shell at 345. Running the shell may cause the client computer to perform additional actions. At 350, the client computer may load a content unit object provided by the server at 355. The content unit object may be, for example, a Flash object, a Silverlight object, a Java object, or an HTML5 object defining all or a portion of the content unit to be incorporated into the first web page.

The content unit object loaded at 350 may include an instruction or call to the shell to open an HTML iframe element. An HTML iframe element can contain another HTML document such as all or a portion of a web page. Many content units, such as Flash units, cannot directly open an HTML iframe element, but can cause, via a call to the HTML shell, an HTML iframe element to be opened at 380. The HTML iframe element opened by the shell at 380 may be constructed to overlap at least a portion of the content unit within the first web page. The HTML shell may, through interaction with the content element, determine the position that the iframe element needs to be so that it appears to be fully contained and integrated within the content unit, even though it is in fact not.

At 385, the client computer may load a second web page using a URI provided by the server. The second web page may be loaded completely, which may include visual content with embedded links and interactive features, audio content, user monitoring and reporting elements, and other elements of a web page. At 390, the client computer may deliver the requested first web page including the content unit loaded at 350 and all or a portion of the second web page displayed within the HTML iframe element opened at 380 superimposed on the content unit.

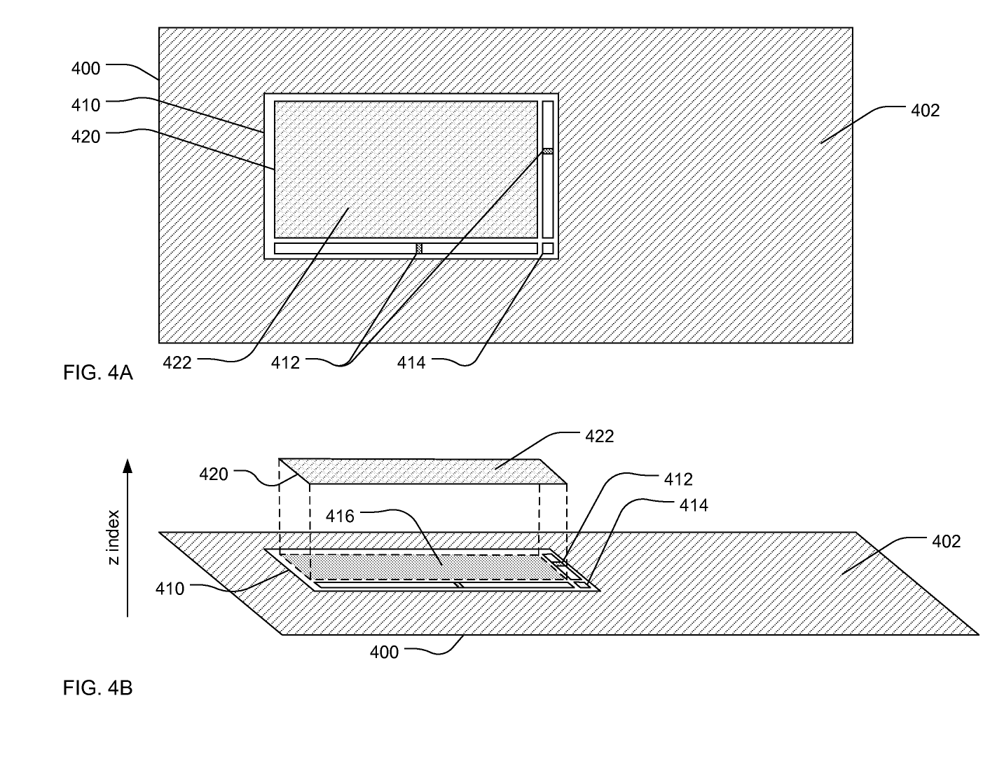

FIG. 4A is a graphic representation of a display screen 400 delivered by the process 300 at 390. The display screen 400 may be provided on a display device coupled to the client computer. FIG. 4B is a perspective representation of objects comprising the display screen 400.

The display screen 400 may include content 402 of a first web page provided by a publisher. The content 402 of the first web page is indicated in FIG. 4A and FIG. 4B with single cross-hatching. The content 402 may include some or all of text, graphics, animation, and video images. The content 402 of the first web page may include a content unit 410 provided separately from the other content 420 of the first web page. An HTML iframe element 420 may also be displayed. The HTML iframe element 420 may be positioned to overlap and conceal all or a portion of the content unit 410. The content 422 of the HTML iframe element 420 may be all or a portion of a second web page, as indicated by double cross-hatching. The second web page may be a page from a second web site.

The content unit 410 may include visible content including some or all of text, graphics, animation, and video images. The content unit 410 may display virtual controls that allow a viewer to control the content 422 displayed within the HTML iframe element 420. For example, the content unit 410 may display scroll bars 412 to control what portion of the second web page is visible within the HTML iframe element and/or a window close button 414 to close the HTML iframe element. The content unit 410 may display virtual controls that emulate a browser “back” button and other controls to allow the viewer to move between pages of the second web site. When permitted by a publisher of the first web page, the content unit 410 may display a virtual control to allow the viewer to expand the extent of the HTML iframe element on the display screen. Only portions of the content unit 410 not occulted by the HTML iframe element 420 may be visible to the viewer. In cases where the HTML iframe element 420 overlaps the entire content unit 410, the content of the content unit 410 may be invisible.

FIG. 4B illustrates a use of layered objects within an HTML document such as a web page. Each object within an HTML document may be assigned to a specific layer as indicated by a “z index” attribute value. Objects having a higher z index value are considered to lie on top of objects having a lower z index value. When visual objects are rendered to a display screen, objects having a higher z index value conceal any underlying objects having a lower z index value.

The first web page content 402 may be assigned, for example, a first z index value. When the content unit 410 is incorporated into the web page 400, the z-index value of the underlying web page content 402 may first be determined. A z-index value higher than the z-index value of the web page content 402 may then be assigned to the content unit 410 such that the content unit 410 overlays the web page. The HTML iframe element 420 may be assigned a still higher z-index value such that, when displayed, the HTML iframe element 420 conceals the underlying portions of the content unit 410. The content 422 of the second web page displayed within the HTML iframe element may be layered independently of the layering of the first web page.

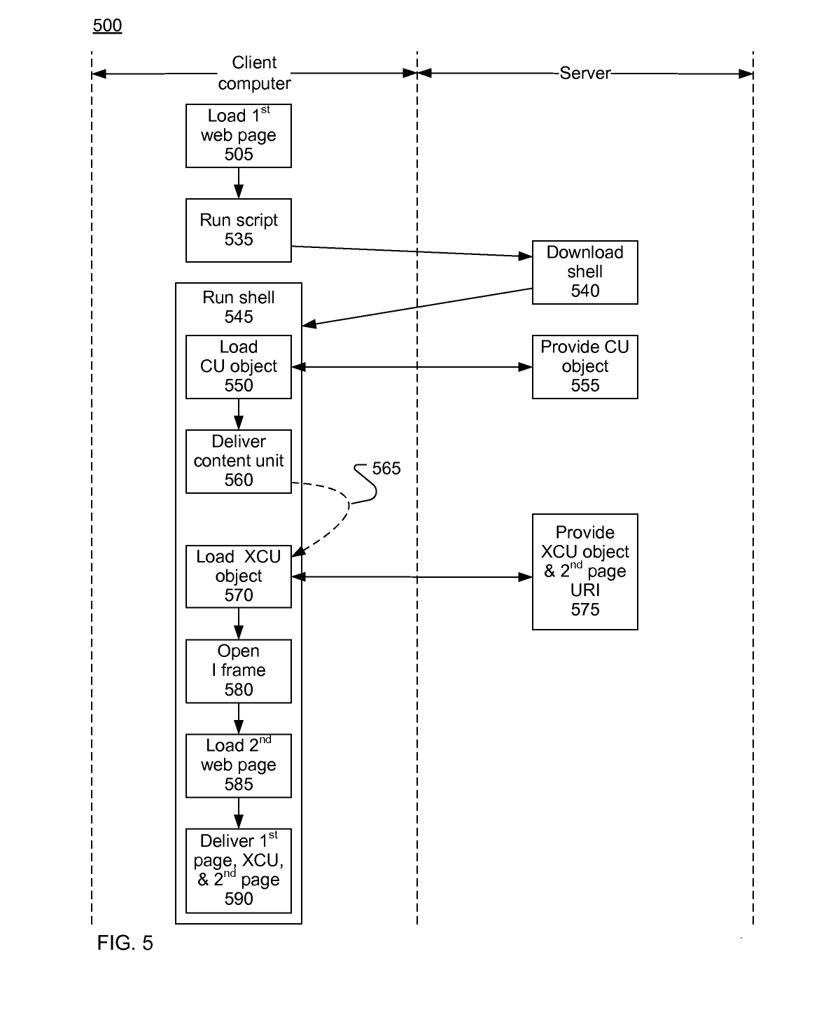

Referring now to FIG. 5, a process 500 for delivering a web page may provide for expansion of a content unit in order to display a larger portion of a second web page. The actions from 505 to 545 are the same as the corresponding actions of the process 300 of FIG. 3 and the description of these actions will not be repeated.

At 550, the client computer may request and then load a content unit (CU) object, provided by the server at 555. The client computer may then deliver the first web page including the content unit at 550.

At 565, the requestor may take an action indicating interest in the subject matter of the content unit. The action may be, for example, a “mouse-over” (moving a cursor over the content unit using a mouse or other pointing device). In response to the requestor's action, the shell may cause the client computer to request and load, at 570, an expanded content unit (XCU) object provided by the ad server at 575. The XCU object may define a content unit of sufficient size to display a meaningful portion of a second web page.

The XCU object loaded at 570 may include an instruction or call to the shell to open an HTML iframe element at 580. The HTML iframe element opened at 580 may be constructed to overlap all or a portion of the expanded add unit within the first web page.

At 585, the client computer may download the second web page using a URI provided by the ad server. The second web page may be loaded completely, which may include visual content with embedded links and interactive features, audio content, user monitoring and reporting elements, and other elements of a web page. At 590, the client computer may deliver the requested first web page including the expanded content unit loaded at 570 and all or a portion of the second web page displayed within the HTML iframe element opened at 580 superimposed on the content unit.

In some circumstances, the publisher of the first web page may not allow a content unit to expand to a sufficient size to display a desired content set from the second web page. In an extreme example, the second web page may be larger than the first web page and simply cannot be displayed within the first web page. In such cases, the content unit loaded at 550 may be expanded in two phases. In response to the user action at 565, the expanded content unit and a portion of the second web page may be delivered at 590. The user may perform an additional action (such as a mouse-over or click of a portion of the expanded content unit) to expand the content unit and HTML iframe element further, or to open a new browser instance to display the second web page.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for presenting a second web page within an element of a first web page, comprising:
a client computing receiving the first web page including information identifying a content unit to be incorporated into the first web page
the client computer requesting the content unit from a server in accordance with the information identifying the content unit
the server downloading a shell to the client computer
the client computer running the shell, wherein running the shell causes the client computer to automatically perform actions comprising:
loading an object from the server, the object configured to generate the content unit
receiving a URI of a second web page from the server
opening an HTML iframe element positioned to overlay at least a portion of the content unit within the first web page
displaying the first web page including the content unit generated from the object
wherein at least a portion of the second web page is displayed within the HTML iframe element overlaying the content unit.

2. The method of claim 1, wherein the content unit is an ad unit and the server is an ad server.

3. The method of claim 1, wherein the content unit displays at least one virtual control to enable a requestor to control displaying the second web page within the HTML iframe element.

4. The method of claim 3, where the at least one virtual control includes one or more of a control to close the HTML iframe element, a control to scroll the second web page within the HTML iframe element, and a control to expand the HTML iframe element.

5. The method of claim 1, wherein the shell is HTML code that, when received by the client computer, incorporates itself into HTML code defining the first web page.

6. The method of claim 5, wherein the object is a Flash object configured to interact with the shell.

7. The method of claim 6, where in the Flash object issues a call to have the shell open the HTML iframe element.

8. The method of claim 1, further comprising:
in response to a viewer action, expanding the element and the HTML iframe element.

9. A method for delivering online advertisements, comprising:
a server receiving a request from a client computer, the request identifying a content unit to be incorporated into a first web page
in response to the first request, the ad server downloading to the client computer a shell, an object configured to generate the content unit, and a URI of a second web page
wherein the shell is configured to cause the client computer to perform actions including:
opening an HTML iframe element positioned to overlay at least a portion of the content unit when the content unit is incorporated into the first web page
displaying the first web page including the content unit
wherein at least a portion of the second web page is displayed within the HTML iframe element overlaying the content unit.

10. The method of claim 9, wherein the object causes the client computer to display at least one virtual control to enable a requestor to control displaying of the second web page within the HTML iframe element.

11. The method of claim 10, where the at least one virtual control includes one or more of a control to close the HTML iframe element, a control to scroll the second web page within the HTML iframe element, and a control to expand the HTML iframe element.

12. The method of claim 9, wherein the shell is HTML code that, when received by the client computer, incorporates itself into HTML code defining the first web page.

13. The method of claim 12, wherein the object is a Flash object configured to interact with the shell.

14. The method of claim 13, wherein the Flash object is configured to issue a call to instruct the shell to open the HTML iframe element.

15. A computer-readable storage medium storing instructions that, when executed, cause a server to perform actions comprising:
receiving a request from a client computer, the request identifying a content unit to be incorporated into a first web page
in response to the first request, downloading to the client computer a shell, an object configured to generate the content unit, and a URI of a second web page
wherein the shell is configured to cause the client computer to perform actions including:
opening an HTML iframe element positioned to overlay at least a portion of the content unit when the content unit is incorporated into the first web page
displaying the first web page including the content unit
wherein at least a portion of the second web page is displayed within the HTML iframe element overlaying the content unit.

16. The computer-readable storage medium of claim 15, wherein the object is configured to cause the client computer to display at least one virtual control to enable a requestor to control the displaying of the second web page within the HTML iframe element.

17. The computer-readable storage medium of claim 16, where the at least one virtual control includes one or more of a control to close the HTML iframe element, a control to scroll the second web page within the HTML iframe element, and a control to expand the HTML iframe element.

18. The computer-readable storage medium of claim 15, wherein the shell is HTML code that, when received by the client computer, incorporates itself into HTML code defining the first web page.

19. The computer-readable storage medium of claim 18, wherein the object is a Flash object configured to interact with the shell.

20. The computer-readable storage medium of claim 18, wherein the Flash object is configured to issue a call to instruct the shell to open the HTML iframe element.
